(19) United States
(12) Patent Application Publication
(10) Pub. No.: US 2018/0332429 A1
(43) Pub. Date: Nov. 15, 2018

(54) WIRELESS VOICE BOX

(71) Applicant: HON HAI PRECISION INDUSTRY CO., LTD., New Taipei (TW)

(72) Inventors: CHUN-HUNG LAI, New Taipei (TW); CHIH-CHUN CHANG, New Taipei (TW)

(21) Appl. No.: 15/617,537

(22) Filed: Jun. 8, 2017

(30) Foreign Application Priority Data
May 9, 2017 (TW) 106206570

(51) Int. Cl. H04W 4/00; H04R 1/08

(52) U.S. Cl. CPC H04W 4/008; H04R 2420/07; H04R 1/083

(57) ABSTRACT

A wireless voice box not restricted to a one-to-one BLUETOOTH communication mode but able to connect to a variety of devices within a certain proximity comprises a micro controller unit and a radio frequency device, the micro controller unit and the radio frequency device can be communicatively connected to each other.

### FIELD

The subject matter herein generally relates to a wireless voice box.

### BACKGROUND

A conventional wireless voice box is connected to a control device by a BLUETOOTH module. The BLUETOOTH module must operate on a one-to-one basis, thus connecting one wireless voice box to more than one control device is necessary.

### BRIEF DESCRIPTION OF THE DRAWING

Implementations of the present technology will now be described, by way of example only, with reference to the attached FIGURE.

The FIGURE is a schematic diagram of a wireless voice box in accordance with an exemplary embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawing is not necessarily to scale, and the proportions of certain parts may be exaggerated to illustrate details and features of the present disclosure better. The disclosure is illustrated by way of example and not by way of limitation. It should be noted that references to “an” or “one” exemplary embodiment in this disclosure are not necessarily to the same exemplary embodiment, and such references mean “at least one.”

The term “comprising” when utilized, means “including, but not necessarily limited to”; it specifically indicates open-ended inclusion or membership in the so-described combination, group, series, and the like. The term “A and B are communicatively connected with each other” means “a direction of a signal transmitted between A and B may be from A to B, or from B to A”. The term “A is uni-directionally connected to B” means “a signal is transmitted from A to B”.

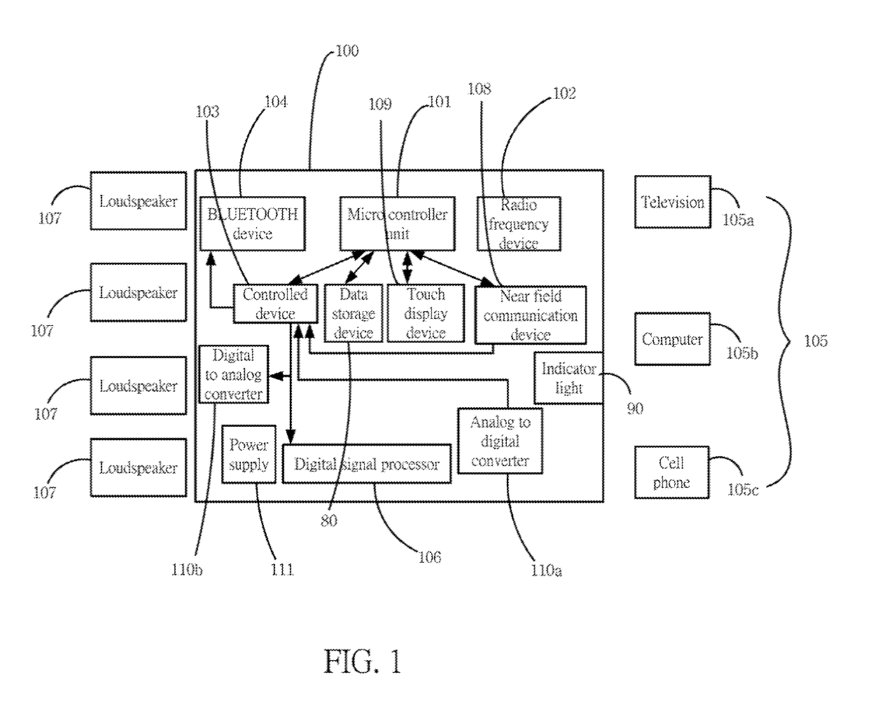

Referring to FIG. 1, a wireless voice box 100 is provided. The wireless voice box 100 comprises a micro controller unit 101 and a radio frequency device 102.

The micro controller unit 101 can be a single chip microcomputer.

The micro controller unit 101 and the radio frequency device 102 are communicatively connected with each other. A signal can be transmitted from the micro controller unit 101 to the radio frequency device 102, and a signal can be transmitted from the radio frequency device 102 to the micro controller unit 101.

The radio frequency device 102 is configured for communicatively connected to at least one controlled device 103. One signal can be transmitted from one controlled device 103 to the radio frequency device 102, and another signal can be transmitted from the radio frequency device 102 to one controlled device 103.

The at least one controlled device 103 can be a microphone 103a with a radio frequency module (not shown), a headset 103b with a radio frequency module (not shown), a high power loudspeaker box 103c with a radio frequency module (not shown), and/or a subwoofer 103d with a radio frequency module (not shown).

In at least exemplary embodiment, the micro controller unit 101 analyzes a sound signal and transmits the sound signal to the radio frequency device 102. The radio frequency device 102 transmits the analyzed sound signal to the headset 103b.

In other exemplary embodiments, the controlled device 103 receives a sound signal and transmits the sound signal to the radio frequency device 102. The radio frequency device 102 receives and transmits the sound signal to the micro controller unit 101, and the micro controller unit 101 analyzes and transmits the analyzed sound signal to the headset 103b, the high power loudspeaker box 103c, and/or the subwoofer 103d.

The wireless voice box 100 can further comprise a BLUETOOTH device 104. The BLUETOOTH device 104 and the micro controller unit 101 are communicatively connected to each other.

The BLUETOOTH device 104 is configured for communicatively connected to the controlling device 105. The controlling device 105 can be a television 105a with a BLUETOOTH module (not shown), a computer 105b with a BLUETOOTH module (not shown) or a cell phone 105c with a BLUETOOTH module (not shown). The computer 105b can be a desktop computer, a notebook computer, or a tablet computer.

The wireless voice box 100 can further comprise a digital signal processor 106. The digital signal processor 106 and the micro controller unit 101 are communicatively connected to each other. The digital signal processor 106 is uni-directionally connected to the radio frequency device 102. A signal can be transmitted from the digital signal processor 106 to the radio frequency device 102.

The wireless voice box 100 can further comprise a loudspeaker 107. The digital signal processor 106 is uni-directionally connected to the loudspeaker 107.

The wireless voice box 100 can further comprise a near field communication device 108. The near field communication device 108 and the micro controller unit 101 are communicatively connected to each other.

The wireless voice box 100 can further comprise a touch display device 109. The touch display device 109 and the micro controller unit 101 are communicatively connected to each other.

The wireless voice box 100 can further comprise an analog to digital converter 110a and a digital to analog converter 110b. The analog to digital converter 110a is uni-directionally connected to the digital signal processor 106. The digital signal processor 106 is uni-directionally connected to the digital to analog converter 110b.

The wireless voice box 100 can further comprise a power supply 111. The power supply 111 can be a lithium battery or a connector for connecting to an external power source.

In at least one exemplary embodiment, the wireless voice box 100 can be used in a karaoke environment.

The near field communication device 108 of wireless voice box 100 distinguishes and connects to at least one attachable controlling device 105 by moving the wireless voice box 100 close to the controlling device 105. The wireless voice box 100 can further comprise at least one indicator light 90. When the wireless voice box 100 is connected to the controlling device 105, one indicator light 90 turns on, and when the wireless voice box 100 is not connected to the controlling device 105, the indicator light 90 is not illuminated. For example, when the wireless voice box 100 is connected to the microphone 103a, the wireless voice box 100 is moved close to the microphone 103a, one indicator light 90 turns on, and the microphone 103a is distinguished and connected to the wireless voice box 100. When the wireless voice box 100 is connected to headset 103b, the wireless voice box 100 is moved close to the headset 103b, one indicator light 90 turns on, and the headset 103b is distinguished and connected to the wireless voice box 100.

An accompanying musical signal is transmitted from the BLUETOOTH module of the television 105a to the BLUETOOTH device 104 of the wireless voice box 100. The BLUETOOTH device 104 receives and transmits the accompanying musical signal to the micro controller unit 101, and the micro controller unit 101 receives and transmits the accompanying musical signal to the digital signal processor 106. At the same time, the microphone 103a receives a sound signal, the sound signal can be from a singer. The radio frequency module of the microphone 103a transmits the sound signal to the radio frequency device 102 of the wireless voice box 100, the radio frequency device 102 receives and transmits the sound signal to the micro controller unit 101, and the micro controller unit 101 receives and transmits the sound signal to the digital signal processor 106. Then, the accompanying musical signal and the sound signal are analyzed and processed by the digital signal processor 106, and the digital signal processor 106 transmits the analyzed and processed signal to the headset 103b, the high power loudspeaker box 103c, and/or subwoofer 103d. In other exemplary embodiments, the analyzed and processed signal can be transmitted to the loudspeaker 107.

In at least one exemplary embodiment, two wireless voice boxes 100 can be communicatively connected to each other. For stereo playback for example, one wireless voice box 100 can be used as a left channel, and another one wireless voice box 100 can be used as a right channel.

The wireless voice box 100 can further comprise a data storage device 80. The analyzed and processed signal is saved in the data storage device 80. The micro controller unit 101 extracts the analyzed and processed signal from the data storage device 80 and transmits the analyzed and processed signal to the radio frequency device 102. The radio frequency device 102 receives and transmits the analyzed and processed signal to the controlled device 103. In at least one exemplary embodiment, the radio frequency device 102 receives and transmits the analyzed and processed signal to the BLUETOOTH device 104, and the BLUETOOTH device 104 receives and transmits the analyzed and processed signal to the controlling device 105.

User can increase or decrease a volume by applying touches to the touch display device 109, a value of the volume can be displayed by the device 109.

The radio frequency device 102 has a one-to-many mode of operation, the wireless voice box 100 with the micro controller unit 101 and the radio frequency device 102 being connectable to more than one controlled device 103.

It is to be understood, even though information and advantages of the present exemplary embodiments have been set forth in the foregoing description, together with details of the structures and functions of the present exemplary embodiments, the disclosure is illustrative only; changes may be made in detail, especially in matters of shape, size, and arrangement of parts within the principles of the present exemplary embodiments to the full extent indicated by the plain meaning of the terms in which the appended claims are expressed.

1. A wireless voice box comprising:
a micro controller unit; and
a radio frequency device, the micro controller unit and the radio frequency device being communicatively connected to each other, thereby allowing a sound signal to be transmitted from the micro controller unit to the radio frequency device, and another sound signal to be transmitted from the radio frequency device to the micro controller unit.

2. The wireless voice box of claim 1, wherein the radio frequency device is configured for communicatively connected to at least one controlled device, the at least one controlled device comprises a microphone with a radio frequency module, a headset with a radio frequency module, a high power loudspeaker box with a radio frequency module, a subwoofer with a radio frequency module.

3. The wireless voice box of claim 2, further comprising a BLUETOOTH device, wherein the BLUETOOTH device and the micro controller unit are communicatively connected to each other.

4. The wireless voice box of claim 3, wherein the BLUETOOTH device is configured for communicatively connected to a controlling device, the controlling device is a television with a BLUETOOTH module, a computer with a BLUETOOTH module, or a cell phone with a BLUETOOTH module.

5. The wireless voice box of claim 4, further comprising a digital signal processor.

6. The wireless voice box of claim 5, wherein the digital signal processor and the micro controller unit are communicatively connected with each other.

7. The wireless voice box of claim 5, wherein the digital signal processor is uni-directionally connected to the radio frequency device.

8. The wireless voice box of claim 5, further comprising a loudspeaker, wherein the digital signal processor is uni-directionally connected to the loudspeaker.

9. The wireless voice box of claim 4, further comprising a near field communication device, wherein the near field communication device and the micro controller unit are communicatively connected to each other.

10. The wireless voice box of claim 1, further comprising a touch display device, wherein the touch display device and the micro controller unit are communicatively connected to each other, the micro controller unit increases or increases a volume of the wireless voice box in response to touches applied to the touch display device, and displays a value of the volume on the touch display device.

11. The wireless voice box of claim 5, further comprising an analog to digital converter, wherein the analog to digital converter is uni-directionally connected to the digital signal processor.

12. The wireless voice box of claim 5, further comprising a digital to analog converter, wherein the digital signal processor is uni-directionally connected to the digital to analog converter.

13. The wireless voice box of claim 5, further comprising a data storage device.

14. The wireless voice box of claim 9, further comprising at least one indicator light, wherein the near field communication device distinguishes and connects to the controlling device when the wireless voice box is close to the controlling device, and the indicator light turns on when the near field communication device connects to the controlling device.

15. The wireless voice box of claim 13, wherein the BLUETOOTH device receives and transmits an accompanying musical signal to the micro controller unit, the micro controller unit receives and transmits the accompanying musical signal to the digital signal processor, the microphone receives a sound signal from a singer and transmits the sound signal to the radio frequency device, the radio frequency device receives and transmits the sound signal to the micro controller unit, and the micro controller unit receives and transmits the sound signal to the digital signal processor, the digital signal processor analyzes and processes the accompanying musical signal and the sound signal, and transmits the analyzed and processed signal to the headset, the high power loudspeaker box, and/or subwoofer, and the analyzed and processed signal is further stored in the data storage device.

16. The wireless voice box of claim 15, wherein the micro controller unit extracts the analyzed and processed signal from the data storage device and transmits the analyzed and processed signal to the radio frequency device, and the radio frequency device receives and transmits the analyzed and processed signal to the controlled device.

17. The wireless voice box of claim 15, wherein the radio frequency device receives and transmits the analyzed and processed signal to the BLUETOOTH device, and the BLUETOOTH device receives and transmits the analyzed and processed signal to the controlling device.

18. The wireless voice box of claim 2, wherein the micro controller unit analyzes and transmits the sound signal to the radio frequency device, and the radio frequency device transmits the sound signal to the headset.

19. The wireless voice box of claim 2, wherein the microphone receives and transmits the sound signal to the radio frequency device, the radio frequency device receives and transmits the sound signal to the micro controller unit, the micro controller unit analyzes and transmits the sound signal to the headset, the high power loudspeaker, and/or the subwoofer.
